(19) United States
(12) Patent Application Publication
(10) Pub. No.: US 2009/0164299 A1
(43) Pub. Date: Jun. 25, 2009

(54) SYSTEM FOR PROVIDING A USER INTERFACE FOR DISPLAYING AND CREATING ADVERTISER DEFINED GROUPS OF MOBILE ADVERTISEMENT CAMPAIGN INFORMATION TARGETED TO MOBILE CARRIERS

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/963,082

(22) Filed: Dec. 21, 2007

(51) Int. Cl. G06Q 30/00

(52) U.S. Cl. 705/10; 705/14

(57) ABSTRACT

A system is described for providing a user interface for displaying and creating advertiser defined groups of mobile advertisement campaign information targeted to mobile carriers. The system may include a processor, a memory and an interface. The memory may store mobile advertisement campaign information and one or more ad groups. The interface may be operatively connected to the memory and the processor and may communicate with users. The processor may be operatively connected to the interface and the memory and may organize the mobile advertisement information into one or more ad groups. The one or more ad groups may be associated with one or more mobile carriers. The processor may send at least a portion of the mobile advertisement campaign information via the interface to a user interface for display to a user. The portion sent to the user may be based on the one or more mobile carriers.

### TECHNICAL FIELD

The present description relates generally to a system and method, generally referred to as a system, providing a user interface for displaying and creating advertiser defined groups of mobile advertisement campaign information targeted to mobile carriers, and more particularly, but not exclusively, to providing an interface for associating ad groups with mobile carriers.

### BACKGROUND

The mobile phone may be increasingly important as an information and content access device. Currently there may be over 2 billion mobile phones globally, versus 800 million personal computers. Mobile operators may be increasingly looking to high value data services as a way to overcome the continuing voice ARPU decline. Billions of dollars may be being spent globally on wireless licenses with billions more in investments in the pipeline for development of infrastructure and services by wireless service and content providers. Carriers may be introducing new data, content and multimedia services as a means of generating new revenue stream, reversing negative ARPU trends, retaining and attracting customers as well as increasing returns on investment, and extending and differentiating their service offering to consumers. The emergence of these wireless technologies may be creating unique opportunities for wireless carriers, advertisers and publishers to generate additional revenue streams through new and existing customers. As consumer adoption of wireless technology continues to increase, marketing via mobile devices may become an important part of all integrated data communications strategies.

Mobile marketing may benefit consumers, mobile service providers, publishers and advertisers by driving incremental revenue, enhancing consumer loyalty and providing convenience for mobile consumers. Mobile data acceptance may have arrived in many parts of the World and may be expected to increase. Mobile destination portals such as YAHOO! may monetize the mobile searches.

The global business model of mobile marketing to date may depend upon subscription revenue and purchases of consumables (i.e. ring tones, wallpapers, etc.). Slow roll-out and relatively small incremental revenue streams may be jeopardizing return on investment on current and future investments. Wireless advertising may now be seen as the great hope in accelerating revenue growth, especially given the experience of online web advertising. Search may be emerging as both a key feature and a potential universal interface for discovering and accessing mobile information.

However, usage patterns for mobile search and Web search may differ, as well as the expectations of the users and the advertisers. Combined with a completely different user experience, these may change the value of clicks and lead opportunities. Most current mobile devices may have limited browser capabilities that do not support the rich feature set of the Web. Handset capabilities may impact the search behavior of mobile users, where the limitations of numeric-pad keyed entry narrow the searched for terms. The small screen size on mobile devices may have an impact on the performance of the search implementations. The size of screens on mobile handsets may limit the creative that can be displayed per listing, and the number of listings per screen. Current web search marketing systems may not account for these physical differences between mobile handsets and computers.

The mobile market place may be very fragmented in terms of handset and network technologies, and this may impact the display of listings and advertiser offer sites. For mobile devices, there may not be an HTML-like standard adhered to by all carriers, and the “standards” that are present may tend to be operator specific, and may be incompatible with other “standards”. This may lead to markets within markets, where, for example in Japan, advertisers may create separate sites and campaigns for IMODE users, and XHTML and WML users. This fragmentation may also be a barrier to entry for advertisers due to the investment required to support the different technologies and interact with each individual carrier. Advertisers may be faced with either a large start-up investment, or foregoing traffic from certain operators.

### SUMMARY

A system is disclosed for providing a user interface for displaying and creating advertiser defined groups of mobile advertisement campaign information targeted to mobile carriers. The system may include a processor, a memory and an interface. The memory may store mobile advertisement campaign information and one or more ad groups. The interface may be operatively connected to the memory and the processor and may communicate with advertisers. The processor may be operatively connected to the interface and the memory and may organize the mobile advertisement information into one or more ad groups. The one or more ad groups may be associated with one or more mobile carriers. The processor may send at least a portion of the mobile advertisement campaign information via the interface to a user interface for display to an advertiser. The portion sent to the advertiser may be based on the one or more mobile carriers.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for providing a user interface for displaying and creating advertiser defined groups of mobile advertisement campaign information targeted to mobile carriers.

FIG. 2 is block diagram of a simplified view of a network environment implementing the system of FIG. 1 or other systems for providing a user interface for displaying and creating advertiser defined groups of mobile advertisement campaign information targeted to mobile carriers.

FIG. 3 is a flowchart illustrating operations of the system of FIG. 1, or other systems for providing a user interface for displaying and creating advertiser defined groups of mobile advertisement campaign information targeted to mobile carriers.

FIG. 4 is a screenshot of a revenue generator's ad group creation interface in the system of FIG. 1, or other systems for providing a user interface for displaying and creating advertiser defined groups of mobile advertisement campaign information targeted to mobile carriers.

FIG. 5 is a screenshot of a revenue generator's keyword selection interface in the system of FIG. 1, or other systems for providing a user interface for displaying and creating advertiser defined groups of mobile advertisement campaign information targeted to mobile carriers.

FIG. 6 is a screenshot of a revenue generator's ad group bid interface in the system of FIG. 1, or other systems for providing a user interface for displaying and creating advertiser defined groups of mobile advertisement campaign information targeted to mobile carriers.

FIG. 7 is a screenshot of a revenue generator's ad group review interface in the system of FIG. 1, or other systems for providing a user interface for displaying and creating advertiser defined groups of mobile advertisement campaign information targeted to mobile carriers.

FIG. 8 is an illustration of a mobile device displaying an advertisement targeted to a geographic area related to the content on the page in the system of FIG. 1 or other systems for providing a user interface for displaying and creating advertiser defined groups of mobile advertisement campaign information targeted to mobile carriers.

FIG. 9 is an illustration a general computer system that may be used in a system for providing a user interface for displaying and creating advertiser defined groups of mobile advertisement campaign information targeted to mobile carriers.

### DETAILED DESCRIPTION

The present description relates generally to a system and method, generally referred to as a system, for providing a user interface for displaying and creating advertiser defined groups of mobile advertisement campaign information targeted to mobile carriers, such as to users of mobile carriers, and more particularly, but not exclusively, to providing an interface for associating ad groups with mobile carriers.

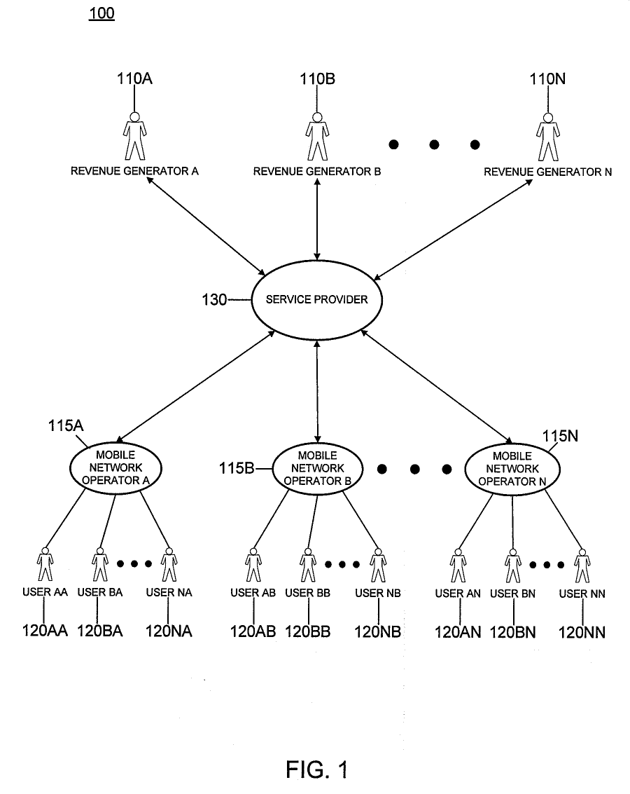

FIG. 1 provides a general overview of a system 100 for providing a user interface for displaying and creating advertiser defined groups of mobile advertisement campaign information targeted to mobile carriers, such as to users of mobile carriers. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as mobile advertisers, a service provider 130, such as a portal or a mobile advertising service provider, one or more mobile network operators (“MNOs”) 115A-N, more commonly referred to as mobile carriers, or simply carriers, and one or more users 120AA-NN, such as mobile subscribers or consumers. The service provider 130 may implement an advertising campaign management system incorporating an auction based and/or non-auction based advertisement serving system.

The revenue generators 110A-N may pay the service provider 130 to serve, or display, advertisements of their goods or services, such as on-line or mobile advertisements, to the users 120AA-NN, such as over mobile messaging, mobile web, the Internet, or generally any venue for displaying advertisements. The advertisements may include sponsored listings, banners ads, popup advertisements, mobile messages, or generally any way of attracting the users 120AA-NN to the web site or mobile site of the revenue generators 110A-N. The users 120AA-NN may utilize the services of the service provider 130 through web applications, mobile applications or standalone applications.

A revenue generator A 110A who is an mobile advertiser may maintain one or more accounts with the service provider 130. For each account the revenue generator A 110A may maintain one or more campaigns. For each campaign the revenue generator A 110A may maintain one or more ad groups. An ad group may be a group of advertisements associated with a group of search queries and a bid. Any one of the advertisements may be displayed to a user AA 120AA if the user AA 120AA searches any one of the queries. The bid may be a cost associated with an action derived from the displayed advertisement. An ad group may also be associated with one or more MNOs 115A-N. In this instance the advertisements in the ad groups may only be displayed to the users 120AA-NN if the users 120AA-NN are communicating with one of the MNOs 115A-N. The association between an advertisement, an MNO A 115A, and a query may be referred to as a listing.

Associating the MNOs 115A-N with the ad groups may allow the service provider 130 to provide a mobile advertising marketplace separate from the web advertising marketplace, essentially separating the web keywords from the mobile keywords. Associating the ad groups with individual MNOs 115A-N may also allow the service provider 130 to provide a separate marketplace for each of the MNOs 115A-N, essentially separating the keywords associated with each of the MNOs 115A-N. For example, the revenue generator A 110A may place one bid on the keyword “dvd” for the MNO A 115A and a separate bid for the keyword “dvd” for the MNO B 115B. Furthermore, by creating a separate marketplace for each of the MNOs 115A-N, the revenue generator A 110A may create separate advertisements compatible with the underlying technology of each MNO.

The service provider 130 may implement the separation of keywords by utilizing a data field to indicate which carriers an ad group may be associated with. Alternatively or in addition, if the database architecture does not support the addition of a separate field, or if the service provider 130 wishes to utilize the functionality of an existing web search marketing system, the keywords for each carrier may be separated by adding prefixes to the keywords. In this case, each of the carriers may be identified by a unique prefix identifier. The prefix identifier may include a combination of the geographical location of the carrier and a descriptor of the carrier. For example, the carrier SPRINT may have a prefix of “usmobsprintsb”.

The prefix may be separated from the keyword by a keyword separator, such as the character string “vxv”. The purpose of the keyword separator may be to identify the location in the character string where the prefix ends and the keyword begins. The “vxv” keyword separator may be particularly functional in this regard, because this sequence of letters may very rarely, or never, appear in the English language. Thus, the presence of the “vxv” character string may indicate the end of the prefix and the beginning of the keyword. For example, if the revenue generator A 110A bid on the keyword “dvd” for users on the carrier SPRINT, the keyword may be stored in an existing search marketing database as “usmobsprintsbvxvdvd”. The service provider 130 may later search for the advertisements associated with SPRINT for the keyword “dvd” by searching for the keyword “usmobsprintsbvxvdvd”.

The service provider 130 may maintain a mobile portal and/or a web portal, such as a search site, where the service provider 130 may display advertisements of the revenue generators 110A-N to the users 120AA-NN. The users 120AA-NN may use mobile devices to interact with the search site provided by the service provider 130 to search for information on the mobile web. One of the users 120AA-NN, such as the user AA 120AA, may communicate a search query to the service provider 130 relating to the information they are searching for. The service provider 130 may provide data related to the query to the users 120AA-NN. Alternatively or in addition the service provider 130 may provide advertisements to a third party server, such as a third party search portal. The third party server may submit an advertisement request to the service provider 130 through an interface such as an application programming interface (“API”). The service provider 130 may use the date submitted with the request to retrieve and return relevant advertisements to the third party server.

Alternatively or in addition the service provider 130 may be an advertising services provider. Third party entities, such as the MNOs 115A-N may request advertisements from the service provider 130 through an API. The service provider 130 may return advertisements of the revenue generators 110A-N to the MNOs 115A-N relating to data submitted in the advertisement request. The MNOs 115A-N may then display the advertisements to the users 120AA-NN. The service provider 130 may share revenue with the mobile network operators MNOs 115A-N of the users 120AA-NN for displaying advertisements of the revenue generators 110A-N via their mobile networks. Alternatively or in addition the service provider 130 may share revenue with individual publishers for displaying advertisements of the revenue generators 110A-N on their mobile and/or web sites. The service provider 130 may supply the API to the MNOs 115A-N enabling the MNOs 115A-N to request advertisements from the service provider 130.

The MNOs 115A-N may provide a mobile network to the users 120AA-NN which may provide a variety of services to the users 120AA-NN, such as the ability to send and receive phone calls, send and receive mobile messages, to access the internet and/or the mobile web, or generally any service that may be implemented on a mobile device. The MNOs 115A-N may store data describing the users 120AA-NN, such as billing addresses, call histories, messaging histories, or generally any data regarding the users 120AA-NN that may be available to the MNOs 115A-N.

The amount the revenue generators 110A-N may pay the service provider 130 may be based on one or more factors. These factors may include impressions, click throughs, conversions, and/or generally any metric relating to the advertisement and/or the behavior of the users 120AA-NN. The impressions may refer to the number of times an advertisement may have been displayed to the users 120AA-NN. The click throughs may refer to the number of times the users 120AA-NN may have clicked through an advertisement to a web site, mobile web site or mobile landing page of one of the revenue generators 110A-N, such as the revenue generator A 110A. The conversions may refer to the number of times a desired action was taken by the users 120AA-NN after clicking though to a web site of the revenue generator A 110A. The desired actions may include submitting a sales lead, making a purchase, viewing a key page of the site, downloading a whitepaper, and/or any other measurable action. If the desired action is making a purchase, then the revenue generator A 110A may pay the service provider 130 a percentage of the purchase.

The users 120AA-NN may be consumers of goods or services who may be searching for a business, such as the business of one of the revenue generators 110A-N. The users 120AA-NN may be searching for the internet presence of one of the revenue generators 110A-N, or the real world, or brick and mortar, presence of one of the revenue generators 110A-N. Alternatively or in addition the users 120AA-NN may be machines or other servers, such as a third party server. The users 120AA-NN may need a user identifier or identification (“user ID”) to access the services of the service provider 130. In order to obtain a user ID the users 120AA-NN may need to supply information describing themselves to the service provider 130, such as gender, and/or age of the users 120AA-NN, or generally any information that may be required for the users 120AA-NN to utilize the services provided by the service provider 130. The service provider 130 may collect user behavior data from the users 120AA-NN when they are logged in, such as queries searched for by the users 120AA-NN, links clicked on by the users 120AA-NN and/or any user interactions with the services provided by the service provider 130. The service provider 130 may also use cookies, such as a browser cookie, to collect user behavior data of users 120AA-NN who are not logged in or who are not otherwise identifiable.

The service provider 130 may serve advertisements relevant to collected user behavior data to the users 120AA-NN, via mobile messages, mobile web pages, or mobile applications. For example, if a user AA 120AA performed searches for sports topics, subscribed for sports alerts, or viewed sports related media or articles, the service provider server 130 may serve a sports related ad to the user AA 120AA with the alert. The revenue generators 110A-N may identify categories to associate their advertisements with, such as sports. Alternatively or in addition, the service provider server 130 may perform content matching on the advertisements of the revenue generators 110A-N and identified interests of the user AA 120AA, such as sports. The service provider 130 may serve advertisements directly to the users 120AA-NN, or the MNOs 115A-N and/or other third party servers may request advertisements from the service provider 130 to display to the users 120AA-NN.

In the system 100, the revenue generators 110A-N may interact with the service provider 130, such as via a web application. The revenue generators 110A-N may send information, such as billing, website or mobile site, queries, and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application. Alternatively or in addition the revenue generators 110A-N may interact with the service provider 130 via a mobile device.

The users 120AA-NN may also interact individually with the service provider 130, through the mobile network operators 115A-N, such as via a mobile phone or any mobile device capable of communicating with the mobile network operators 115A-N. The users 120AA-NN may interact with the service provider 130 via a mobile web based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however the system 100 may apply to any revenue generators 110A-N who may desire to serve advertisements to users 120AA-NN over mobile devices.

A revenue generator A 110A who is a mobile advertiser may maintain one or more accounts with the service provider 130. For each account the revenue generator A 110A may maintain one or more campaigns. For each campaign the revenue generator A 110A may maintain one or more ad groups. An ad group may be an association of one or more queries, one or more advertisements, one or more mobile carriers and one or more bid amounts. Each advertisement may include an advertisement title, an advertisement description, and a mobile site URL, if any. A campaign may be a group of related ad groups.

If the revenue generator A 110A does not have a mobile site URL for the MNO A 115A, the revenue generator A 110A may still bid on a query for the MNO A 115A. In this case, the service provider 130 may dynamically create a “WAP ad.” The “WAP ad” may be an offer landing page containing the phone number of the advertiser and/or the logo of the advertiser. When a user AA 120AA clicks on the advertisement of the revenue generator A 110A who does not have a mobile site, the user AA 120AA may be taken to a page showing the phone number and/or logo of the revenue generator A 110A. The user AA 120AA may then use their mobile device to call the phone number of the revenue generator A 110A and complete their transaction. The data associated with the “WAP ad” may be stored in the advertisement title and/or the advertisement description fields.

The queries may represent one or more keywords that the revenue generator A 110A wishes to associate with their advertisements. If the queries appear in a mobile message, a mobile search request, or the content of a mobile page, one of the advertisements of the revenue generator A 110A may be displayed to the user AA 120AA. The advertisement title may represent the data the revenue generator A 110A wishes to be displayed to a user AA 120AA. Alternatively or in addition, the advertisement description may represent the data the revenue generator A 110A wishes to be displayed to a user AA 120AA when the user AA 120AA receives a mobile message containing the query. The mobile site URL may represent the link the revenue generator A 110A wishes a user AA 120AA to be directed to upon clicking on the mobile advertisement of the revenue generator A 110A, such as the home page of the revenue generator A 110A. The bid amount may represent a maximum amount the revenue generator A 110A may be willing to pay each time a user AA 120AA may click on the mobile advertisement of the revenue generator A 110A or each time the mobile advertisement of the revenue generator A 110A may be shown to a user AA 120AA.

There may be some instances where multiple revenue generators 110A-N may have bid on the same queries for one of the MNOS 115A-N. The service provider 130 may serve to the users 120AA-NN the advertisements that the users 120AA-NN may be most likely to click on. For example, the service provider 130 may include a relevancy assessment to determine the relevancy of the multiple mobile advertisements to the queries. The more relevant a mobile advertisement may be to the query the more likely it may be that the user AA 120AA may click on the advertisement.

More detail regarding the aspects of auction-based systems, as well as the structure, function and operation of the service provider 130, as mentioned above, can be found in commonly owned U.S. patent application Ser. No. 10/625,082, filed on Jul. 22, 2003, entitled, “TERM-BASED CONCEPT MARKET”; U.S. patent application Ser. No. 10/625,000, file on Jul. 22, 2003, entitled, “CONCEPT VALUATION IN A TERM-BASED CONCEPT MARKET” filed on Jul. 22, 2003; U.S. patent application Ser. No. 10/625,001, filed on Jul. 22, 2003, entitled, “TERM-BASED CONCEPT INSTRUMENTS”; and U.S. patent application Ser. No. 11/489,386, filed on Jul. 18, 2006, entitled, “ARCHITECTURE FOR AN ADVERTISEMENT DELIVERY SYSTEM,” all of which are hereby incorporated herein by reference in their entirety. The systems and methods herein associated with ad campaign management may be practiced in combination with methods and systems described in the above-identified patent applications incorporated by reference.

More detail regarding the aspects of a mobile advertising auction-based systems, as well as the structure, function and operation of the service provider 130 as a mobile advertising provider, as mentioned above, can be found in commonly owned U.S. patent application Ser. No. 11/712,276, filed on Feb. 28, 2007, entitled, “SYSTEM FOR SERVING ADVERTISEMENTS OVER MOBILE DEVICES,” which is hereby incorporated herein by reference in its entirety. The systems and methods herein associated with mobile advertising campaign management may be practiced in combination with methods and systems described in the above-identified patent application incorporated by reference.

Furthermore, the service provider 130 may generate reports based on the data collected from the user interactions and communicate the reports to the revenue generators 110A-N to assist the revenue generators 110A-N in measuring the effectiveness of their mobile advertising. The reports may indicate the number of times the users 120AA-NN searched for the keywords bid on by the revenue generators 110A-N, the number of times a mobile advertisement of the revenue generators 110A-N was displayed to the users 120AA-NN, and the number of times the users 120AA-NN clicked through on the advertisements of the revenue generators 110A-N. There may be a separate report for each MNO 115A-N the revenue generator A 110A maintains a carrier listing for. There may be a report displaying the aggregate data across all of the MNOs 115A-N the revenue generator A 110A maintains an carrier listing for. The reports may also generally indicate any data that may assist the revenue generators 110A-N in measuring the effectiveness of their mobile advertising campaigns.

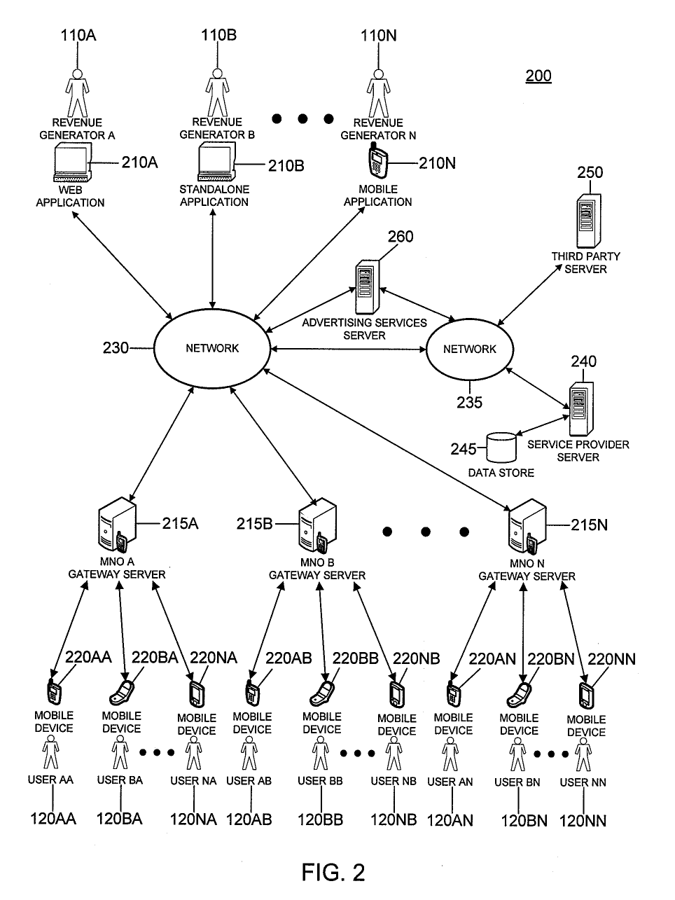

FIG. 2 provides a simplified view of a network environment implementing a system 200 for providing a user interface for displaying and creating advertiser defined groups of mobile advertisement campaign information targeted to mobile carriers, such as to users of mobile carriers. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, or mobile apps, which may be running on one or more mobile devices 220AA-NN. The system 200 may also include one or more MNO gateway servers 215A-N, a network 230, a network 235, the service provider server 240, a data store 245, a third party server 250, and an advertising services server 260.

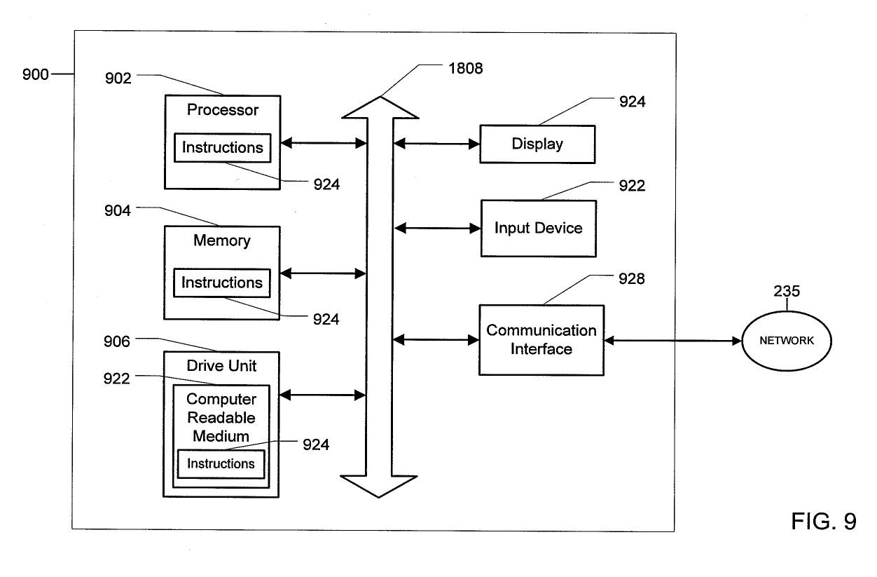

Some or all of the advertisement services server 260, service provider server 240, and third-party server 250 may be in communication with each other by way of network 235 and may be the system or components described below in FIG. 9. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with, an MNO gateway server 215A-N.

The data store 245 may be operative to store data, such as data relating to interactions with the users 120AA-NN. The data store 245 may include one or more relational databases or other data stores that may be managed using various known database management techniques, such as, for example, SQL and object-based techniques. Alternatively or in addition the data store 245 may be implemented using one or more of the magnetic, optical, solid state or tape drives. The data store 245 may be in communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N.

The users 120AA-NN may use a mobile application running on a mobile device 220AA-220NN, such as a mobile web browser, to communicate with the service provider server 240, via the MNO gateway servers 215A-N and the networks 230, 235. The service provider server 240 may communicate to the users 120AA-NN via the networks 230, 235 and the MNO gateway servers 215A-N, through the mobile devices 220AA-NN.

The web applications, standalone applications, mobile applications and mobile devices 210A-N, 220AA-NN may be connected to the network 230 in any configuration that supports data transfer. This may include a data connection to the network 230 that may be wired or wireless. Any of the web applications, standalone applications and mobile applications 210A-N, 220AA-NN may individually be referred to as a client application. The web application 210A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone applications 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with the revenue generator B 110B. The communication interface may be operatively connected to the memory, and the processor, and may be capable of communicating through the networks 230, 235 with the service provider server 240, third party server 250 and advertising services server 260. The standalone application 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 210N may run on any mobile device which may have a data connection. The mobile applications 210N may be a web application 210A, a standalone application 210B, or a mobile browser. The mobile devices 220AA-NN may be one of a broad range of electronic devices which may include mobile phones, PDAs, and laptops and notebook computers. The mobile devices 220AA-NN may have a reduced feature set, such as a smaller keyboard and/or screen, and may be incapable of supporting a traditional web search.

The data connection of the mobile devices 220AA-NN may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the MNO gateway servers 215A-N.

The MNO gateway servers 215A-N may control the access the mobile devices 220AA-NN may have to the networks 230, 235. The MNO gateway servers 215A-N may also control the technology supporting the respective mobile devices 220AA-NN. This may affect aspects of the user experience, such as signal strength and availability, speed and billing mechanisms. For example, the MNO A gateway server 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile devices 220AA-NN may only support one of the aforementioned formats.

The MNOs 115A-N may utilize various components to provide these services to the users 120AA-NN, such as network switching systems (“NSS”), mobile switching centers (“MSC”), mobile switching center servers (“MSC-S”), home location registers (“HLR”), authentication centers (“AUC”), short message service centers (“SMSC”), signal transfer points (“STP”), message service centers (“MSC”), or generally any component that may be utilized to provide the mobile services. The MNOs 115A-N may interface with one or more external short messaging entities (ESME), such as the third party server 250, which may connect to the MNOs 115A-N to send and/or receive mobile messages to the users 120AA-NN. The ESMEs may provide voicemail, web, email, or other services to the users 120AA-NN of the MNOs 115A-N.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may collectively be referred to as the server. The service provider server 240 may receive requests from the users 120AA-NN and the revenue generators 110A-N and may serve web pages and/or mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. Alternatively or in addition, the third party server may be an ESME server. The advertising services server 260 may provide a platform for the inclusion of advertisements in pages, such as web pages or mobile pages. The advertisement services server 260 may be used for providing mobile advertisements that may be displayed to the users 120AA-NN. The third party server 250 may request advertisements from the service provider server 240 or the advertisement services server 260 via an API.

The service provider server 240, the third party server 250 and the advertising services server 260 may be one or more computing devices of various kinds, such as the computing device in FIG. 9. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server 260 may provide a platform for the inclusion of advertisements in pages, such as web pages. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

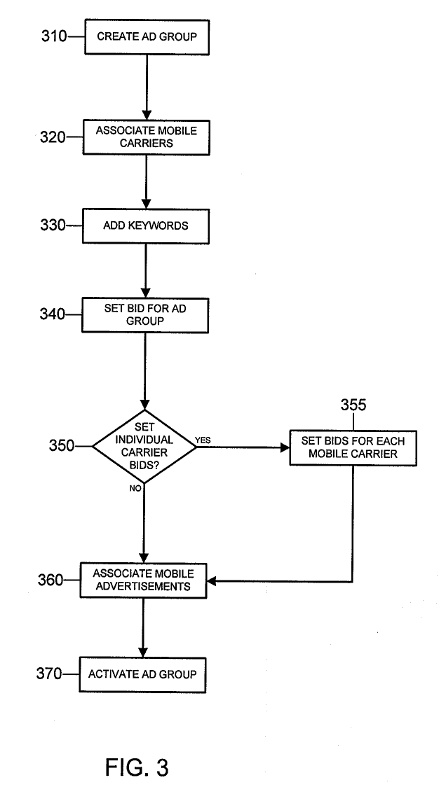

FIG. 3 is a flowchart illustrating operations of the system of FIG. 1, or other systems for providing a user interface for displaying and creating advertiser defined groups of mobile advertisement campaign information targeted to mobile carriers, such as to users of mobile carriers. One of the revenue generators 110A-N, such as the revenue generator A 110A, may carry out the operations illustrated in FIG. 3 by utilizing an interface provided by the service provider 130. At block 310 the revenue generator A 110A may use an interface provided by the service provider 130 to create an ad group. The ad group may consist of a name, keywords, advertisements, a search tactic, such as sponsored search, content matching, or any other tactic used to attract users 120AA-NN to a mobile page of the revenue generators 110A-N, and a selection of MNOs 115A-N to be associated with the ad group. At block 320 the revenue generator A 110A may select one or more of the MNOs 115A-N to associate with the ad group. The advertisements associated with the ad group will only be served to the users 120AA-NN if the users 120AA-NN are in communication with the one or more mobile carriers associated with the ad group.

At block 330 the revenue generator A 110A may add keywords to the ad group. The keywords, or queries, may be one or more terms that one of the users 120AA-NN may search for on the mobile web. When the users 120AA-NN search for the keywords on the mobile web, while in communication with one of the selected MNOs 115A-N, the service provider 130 may serve one of the advertisements of the revenue generator A 110A to the users 120AA-NN. At block 340 the revenue generator A 110A may set the bid for the ad group. The bid for the ad group may be the amount a revenue generator A 110A may pay the service provider 130 when one of the users 120AA-NN takes a desired action after viewing an advertisement of the revenue generator A 110A while in communication with one of the MNOs 115A-N associated with the ad group. The bid for the ad group may apply to any of the advertisements associated with the ad group when displayed via any of the MNOs 115A-N associated with the ad group.

At block 350 the revenue generator A 110A may determine whether to set individual bids for each of the MNOs 115A-N. The individual bids may override the bid for the ad group. The revenue generator A 110A may indicate a desire to set individual bids by selecting a checkbox on the interface. If at block 350 the revenue generator A 110A wants to set individual bids for one or more of the MNOs 115A-N the system 100 may move to block 355. At block 355 the revenue generator A 110A may set individual bids for one or more of the MNOs 115A-N. For example, the revenue generator A 110A may value a click-through on MNO A 115A more than a click-through on MNO B 115B, and may set the bids for each of the MNOs 115A-B accordingly. The system 100 may then move to block 360.

If at block 350 the revenue generator A 110A does not wish to set individual bids for the mobile carriers 115A-N, then the system 100 may move to block 360. At block 360 the revenue generator A 110A may associate mobile advertisements with the ad group. The mobile advertisements may be one or more advertisements that may be displayed to the users 120AA-NN when the users 120AA-NN search for one of the keywords in the ad group via one of the MNOs 115A-N associated with the ad group. At block 370 the revenue generator A 110A may review the add group and activate the ad group. The ad group may be activated by clicking a “submit” button.

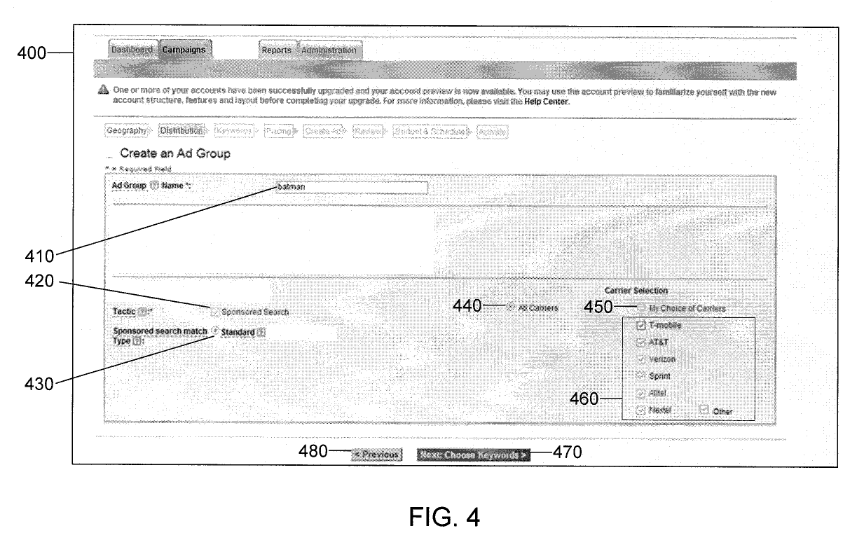

FIG. 4 is a screenshot of a revenue generator's interface 400 for creating ad groups in the system of FIG. 1, or other systems for providing a user interface for displaying and creating advertiser defined groups of mobile advertisement campaign information targeted to mobile carriers, such as to users of mobile carriers. The interface 400 may include an ad group name field 410, one or more advertising tactic checkboxes 420, a match type selector 430, an all carriers selector 440, an individual carrier selector 450, individual carrier checkboxes 460, a previous button 480, and a next button 470.

In operation, one of the revenue generators 110A-N, such as the revenue generator A 110A, may interact with the interface 400 to create an ad group. The revenue generator A 110A may enter a name for the ad group in the ad group name field 410. The revenue generator A 110A may select one or more advertising tactic checkboxes 420 to associate with the ad group. The advertising tactic may refer to the method of advertising, such as content matching, sponsored search, behavioral profiling, or generally any means for the revenue generator A 110A to attract the users 120AA-NN to their mobile and/or web properties. Any advertising tactics available to the revenue generators 110A-N in traditional web advertising may also be available to the revenue generators 110A-N in the interface 400. Alternatively or in addition the interface 400 may provide the revenue generators 110A-N with the option of using mobile specific advertising tactics, such as mobile messaging advertising, or mobile application advertising. If the revenue generator A 110A selects the sponsored search tactic the revenue generator A 110A may select the search match type to use in the match type selector 430. The match type may be advanced matching, or generally any other type of matching. The revenue generator A 110A may select to target the ad group to all carriers by using the all carriers selector 440. The revenue generator A 110A may target the ad group to individual carriers by selecting the individual carrier selector 450. The revenue generator A 110A may select one or more individual carriers with the individual carrier checkboxes 460.

Once the revenue generator A 110A has created the ad group the revenue generator A 110A may click on the next button 470 to move to the next interface, or the previous button 480 to move to the previous interface. If the revenue generator A 110A clicks on the next button 470 the system 100 may provide the revenue generator A 110A with the interface 500.

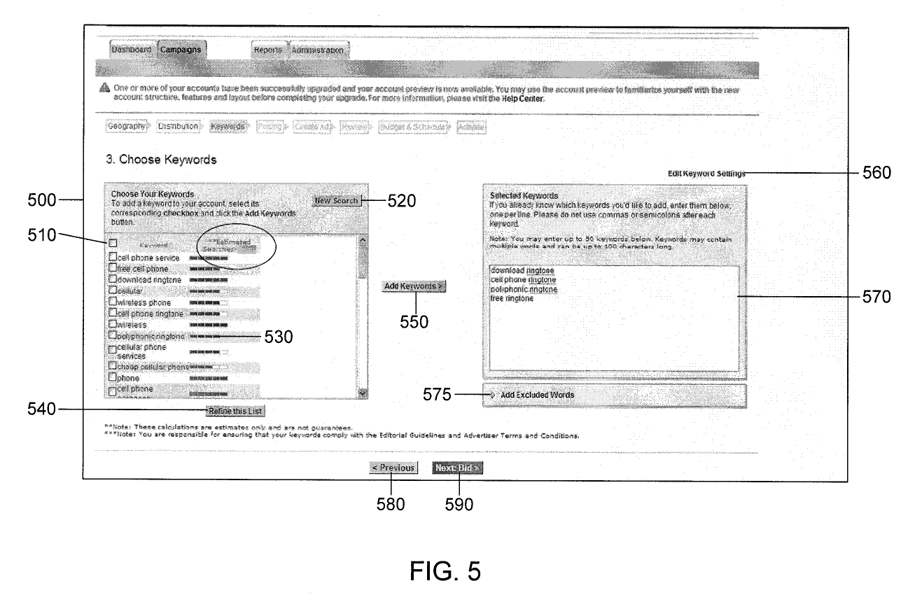

FIG. 5 is a screenshot of a revenue generator's interface 500 for selecting keywords in the system of FIG. 1, or other systems for providing a user interface for displaying and creating advertiser defined groups of mobile advertisement campaign information targeted to mobile carriers, such as to users of mobile carriers. The interface 500 may include keyword checkboxes 510, a new search button 520, estimated search bars 530, a refine list button 540, an add keywords button 550, an edit keyword settings link 560, a selected keyword box 570, an add excluded keyword button 575, a previous button 580 and a next button 590.

In operation the revenue generator A 110A may use the interface 500 for adding keywords to the ad group. The keyword checkboxes 510 may be used to select a set of keywords to add to the ad group. The revenue generator A 110A may have used a search tool to search for one or more keywords and the system 100 may have displayed the list of suggested keywords. The revenue generator A 110A may be able to submit a new keyword search by clicking on the new search button 520. The new search button 520 may provide the revenue generator A 110A with search text box for entering a new search query. Performing a new search may result in a new list of suggested search queries. The estimated search bars 530 may indicate the number of searches the revenue generator A 110A may expect to receive from the keyword. The revenue generator A 110A may click on the refine list button 540 to refine the list of keywords. The refine list button 540 may provide the revenue generator with a text field with the query used to generate the list of keywords. The revenue generator A 110A may the modify the original search query to refine the list of keywords.

The revenue generator A 110A may mark one or more keyword checkboxes 510 and then click on the add keywords button 550 to add the selected keywords to the selected keyword box 570. The selected keyword box 570 may display all of the keywords currently selected for the ad group. The revenue generator A 110A may edit the keyword settings by clicking on the edit keyword settings link 560. The revenue generator A 110A may exclude certain words from the selected keyword box 570. The revenue generator may re-add the excluded keywords by clicking on the add excluded keyword button 575.

Once the revenue generator A 110A has selected the keywords to add to the ad group the revenue generator A 110A may click on the next button 590 to move to the next interface, or the previous button 580 to move to the previous interface. If the revenue generator A 110A clicks on the next button 590, the system 100 may provide the revenue generator with the interface 600. If the revenue generator A 110A clicks on the previous button 580, the system 100 may provide the revenue generator with the interface 400.

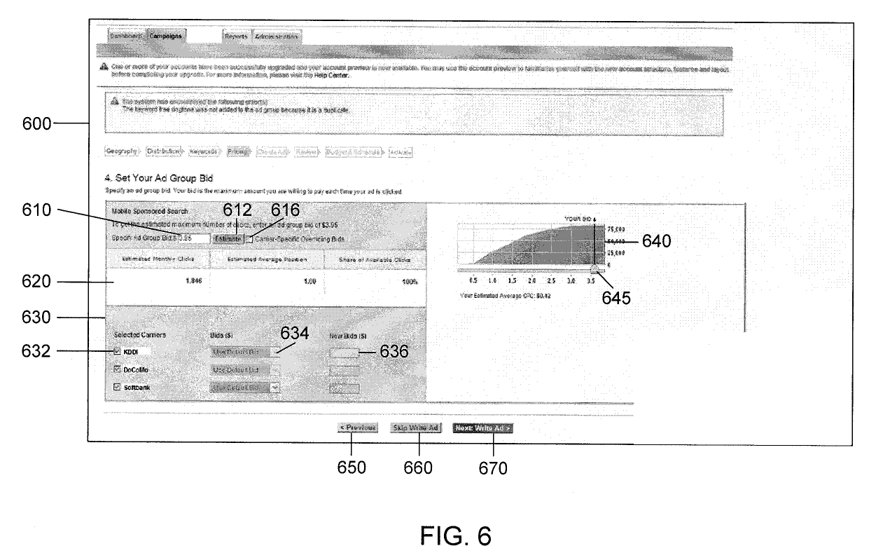

FIG. 6 is a screenshot of a revenue generator's interface 600 for bidding on ad groups in the system of FIG. 1, or other systems for providing a user interface for displaying and creating advertiser defined groups of mobile advertisement campaign information targeted to mobile carriers, such as to users of mobile carriers. The interface 600 may include an ad group bid field 610, an estimate button 612, a carrier specific checkbox 616, a estimated clicks display 620, a estimated graph 640, a slider bar 645, an individual carrier section 630, a previous button 650, a skip write ad button 660, and a next button 670. The individual carrier section 630 may include selected carrier checkboxes 632, bid drop downs 634, and new bid text fields 636.

In operation the revenue generator A 110A may use the interface 600 to bid on ad groups. The revenue generator may place one bid across all of the MNOs 115A-N associated with an ad group, or may specify individual bids for each of the MNOs 115A-N associated with an ad group. The revenue generator A 110A may enter a bid in the ad group bid field 610. The revenue generator A 110A may click on the estimate button 612 to see the estimated monthly clicks for the bid, estimated average position for the bid and estimated share of available clicks for the bid in the estimated clicks display 620. The estimated graph 640 may show a graph of the estimated clicks for the bid. The revenue generator A 110A may be able to move the slider bar 645 to view the estimated clicks for other bid amounts.

The revenue generator A 110A may set individual bids for each of the MNOs 115A-N associated with the ad group by clicking on the carrier specific checkbox 616. The revenue generator A 110A may then enter individual bids for each of the MNOs 115A-N associated with the ad group in the individual carrier section 630. The individual carrier section 630 may show each of the MNOs 115A-N the revenue generator A 110A associated with the ad group via the interface 400. The revenue generator A 110A user the carrier checkboxes 632 to select which of the carriers to change the bid for. The bid drop downs 634 may have several options for the revenue generator A 110A, such as “Use default bid”, “Set New Bid”, or generally any action relating to setting the bids. If the revenue generator A 110A selects the option in the drop down 634 associated with setting a new bid, such as “Set New Bid,” then the revenue generator A 110A may set a new bid in the new bid checkbox 636.

Once the revenue generator has identified bids for the MNOs 115A-N, through either one bid for all of the MNOs 115A-N, or through setting individual bids for each of the MNOs 115A-N, the revenue generator A 110A may click on the next button 670. The next button 670 may present the revenue generator A 110A with an interface for creating one or more advertisements for the ad group. If the revenue generator A 110A already has advertisements created for the ad group, or otherwise does not wish to create advertisements for the ad group, the revenue generator A 110A may click on the skip write ad button 660. If the revenue generator A 110A selects the skip write ad button 660 the system 100 may provide the revenue generator A 110A with the interface 700. If the revenue generator A 110A clicks on the previous button 650, the system 100 may provide the revenue generator A 110A with the interface 500.

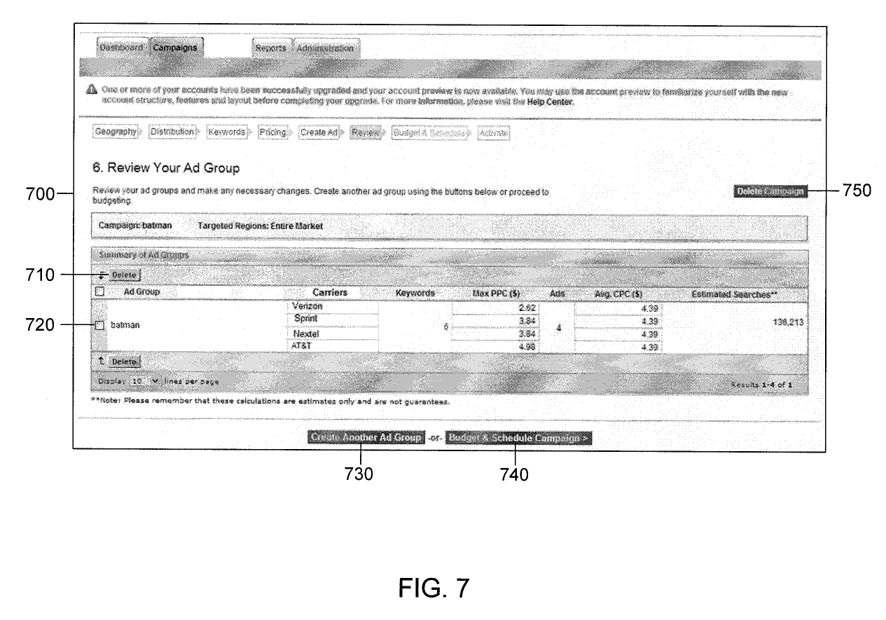

FIG. 7 is a screenshot of a revenue generator's interface 700 for reviewing ad groups in the system of FIG. 1, or other systems for providing a user interface for displaying and creating advertiser defined groups of mobile advertisement campaign information targeted to mobile carriers, such as to users of mobile carriers. The interface 700 may include a delete button 710, an ad group checkbox 720, a delete campaign button 750, a create another button 730 and a budget button 740.

In operation the revenue generator A 110A may review the ad groups which have been created through the system 100. The interface 700 may display data associated with each ad group created by the revenue generator A 110A, such as the MNOs 115A-N associated with the ad group, the number of keywords associated with the ad group, the maximum bids for each MNO 115A-N associated with the ad group, the number of advertisements associated with the ad group, the estimated average cost per click for each of the MNOs 115A-N, and the estimated number of searches for the ad group. The revenue generator A 110A may delete one or more of the ad groups by checking the ad group checkbox 720 associated with the ad group and clicking on the delete button 710. The revenue generator A 110A may delete the entire campaign by clicking on the delete campaign button 750.

Once the revenue generator A 110A has reviewed the ad groups the revenue generator A 110A may click on the create another button 730 to create another ad group. If the revenue generator A 110A clicks on the create another button 730 the system 100 may provide the revenue generator A 110A with the interface 400. If the revenue generator A 110A clicks on the budget button 740, the system 100 may provide the revenue generator A 110A with the an interface for setting a budget for the campaign. If the revenue generator A 110A clicks on either of the buttons 730, 740, the ad group may be activated for the MNOs 115A-N selected by the revenue generator A 110A.

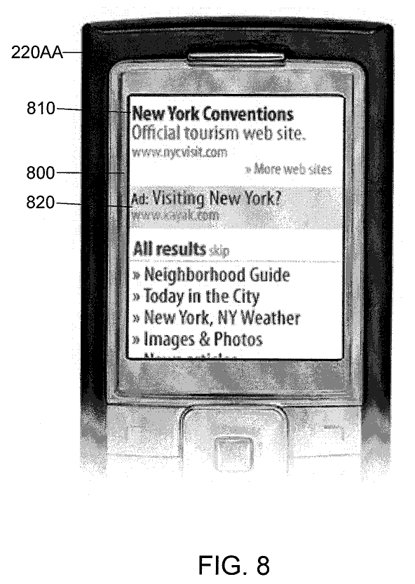

FIG. 8 illustrates a mobile device 220AA displaying a mobile advertisement of a revenue generator A 110A in the system of FIG. 1 or other systems for providing a user interface for displaying and creating advertiser defined groups of mobile advertisement campaign information targeted to mobile carriers. The mobile device 220AA may include a screen 800, a search result 820 and an advertisement 830. The screen 800 may be displayed to the user AA 120AA after the user AA 120AA searches for “New York” though a mobile search portal. The advertisement 830 may relate to the mobile search performed by the user AA 120AA.

FIG. 9 illustrates a general computer system 900, which may represent a service provider server 240, a third party server 250, an advertising services server 260, one of the mobile devices 220AA-NN or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 900 may include a set of instructions 924 that may be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 900 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 924 (sequential or otherwise) that specify actions to be taken by that machine. In a particular embodiment, the computer system 900 may be implemented using electronic devices that provide voice, video or data communication. Further, while a single computer system 900 may be illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, such as, a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 904 may include a cache or random access memory for the processor 902. Alternatively or in addition, the memory 904 may be separate from the processor 902, such as a cache memory of a processor, the system memory, or other memory. The memory 904 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 904 may be operable to store instructions 924 executable by the processor 902. The functions, acts or tasks illustrated in the figures or described herein may be performed by the programmed processor 902 executing the instructions 924 stored in the memory 904. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 900 may further include a display 914, such as a liquid crystal display (LCD), an organic light emitting diode (OLED), a flat panel display, a solid state display, a cathode ray tube (CRT), a projector, a printer or other now known or later developed display device for outputting determined information. The display 914 may act as an interface for the user to see the functioning of the processor 902, or specifically as an interface with the software stored in the memory 904 or in the drive unit 906.

Additionally, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the system 900.

The computer system 900 may also include a disk or optical drive unit 906. The disk drive unit 906 may include a computer-readable medium 922 in which one or more sets of instructions 924, e.g. software, can be embedded. Further, the instructions 924 may perform one or more of the methods or logic as described herein. The instructions 924 may reside completely, or at least partially, within the memory 904 and/or within the processor 902 during execution by the computer system 900. The memory 904 and the processor 902 also may include computer-readable media as discussed above.

The present disclosure contemplates a computer-readable medium 922 that includes instructions 924 or receives and executes instructions 924 responsive to a propagated signal; so that a device connected to a network 235 may communicate voice, video, audio, images or any other data over the network 235. The instructions 924 may be implemented with hardware, software and/or firmware, or any combination thereof. Further, the instructions 924 may be transmitted or received over the network 235 via a communication interface 918. The communication interface 918 may be a part of the processor 902 or may be a separate component. The communication interface 918 may be created in software or may be a physical connection in hardware. The communication interface 918 may be configured to connect with a network 235, external media, the display 914, or any other components in system 900, or combinations thereof. The connection with the network 235 may be a physical connection, such as a wired Ethernet connection or may be established wirelessly as discussed below. Likewise, the additional connections with other components of the system 900 may be physical connections or may be established wirelessly. In the case of a service provider server 240, a third party server 250, an advertising services server 260, the servers may communicate with users 120AA-NN and the revenue generators 110A-N through the communication interface 918.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 922 may be a single medium, or the computer-readable medium 922 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 922 may include a solid-state memory such as a memory card or other package that houses one or more non-volatile read-only memories. The computer-readable medium 922 also may be a random access memory or other volatile re-writable memory. Additionally, the computer-readable medium 922 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The functions described herein may also be accomplished by way of an application program interface for facilitating a display of mobile advertisement ad groups associated with mobile carriers. Information associated with a mobile ad group and at least one carrier and at least one keyword associated with the mobile ad group may be communicated via the application program interface.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for facilitating the display of mobile advertisement campaign information, comprising:
organizing mobile advertisement campaign information into one or more ad groups, wherein each ad group is associated with one or more mobile carriers; and
sending at least a portion of the mobile advertisement campaign information to a user interface for display based at least in part on at least the one or more mobile carriers.

2. The method of claim 1 wherein at least one of the one or more ad groups comprises advertiser customized and defined groups of mobile advertisement campaign data.

3. The method of claim 1 wherein a bid amount is associated with at least one of the one or more mobile carriers.

4. The method of claim 1 wherein at least one keyword and at least one mobile advertisement is associated with at least one ad group.

5. The method of claim 4 wherein the at least one mobile advertisement is displayed to a user when the user searches for the at least one keyword via one of the mobile carriers.

6. The method of claim 1, wherein sending at least a portion of the mobile advertisement campaign information to a user interface for display based at least in part on at least one of the one or more mobile carriers comprises: sending a graphical illustration of a parameter associated with one of the one or more ad groups over a period of time to the user.

7. The method of claim 1, wherein organizing mobile advertisement campaign information into one or more ad groups comprises:
receiving commands from a user defining how to organize the mobile advertisement campaign information into one or more ad groups; and
receiving commands from a user indicating the one or more mobile carriers to associate with the one or more ad groups.

8. The method of claim 1, wherein the at least a portion of the mobile advertisement campaign information is displayed in a graphical user interface to a user.

9. The method of claim 9, wherein the graphical user interface is displayed in an internet browser.

10. The method of claim 9, wherein the graphical user interface is displayed in a stand-alone application.

11. A method of providing an interface for creating a mobile ad group, comprising:
providing an interface enabling an advertiser to identify one or more keywords, one or more mobile carriers, and one or more advertisements;
associating the one more keywords, the one or more mobile advertisements, and the one or more mobile carriers; and
providing one of the one or more mobile advertisements to a mobile device associated with one of the one or more mobile carriers when a user uses the mobile device to search for one of the one or more keywords.

12. The method of claim 11 wherein the interface enables the advertiser to associate a bid amount with each mobile carrier in the one or more mobile carriers.

13. The method of claim 12 further comprising charging an account of the advertiser the bid amount associated with the mobile carrier associated with the mobile device.

14. The method of claim 11, wherein the at least a portion of the mobile advertisement campaign information is displayed in a graphical user interface to the advertiser.

15. The method of claim 14, wherein the graphical user interface is displayed in an internet browser.

16. The method of claim 14, wherein the graphical user interface is displayed in a stand-alone application.

17. A system for facilitating display of mobile advertisement campaign information to a user, comprising:
a memory to store mobile advertisement campaign information and one or more ad groups;
an interface operatively connected to the memory, the interface to communicate with a user; and
a processor operatively connected to the memory and the interface, the processor for running instructions, wherein the processor organizes the mobile advertisement campaign information into one or more ad groups, further wherein each ad group is associated with one or more mobile carriers, and sends at least a portion of the mobile advertisement campaign information via the interface to a user interface for display to the user, based at least in part on the one or more mobile carriers.

18. The system of claim 17 wherein at least one of the one or more ad groups comprises advertiser customized and defined groups of mobile advertisement campaign data.

19. The system of claim 17 wherein a bid amount is associated with at least one of the one or more mobile carriers.

20. The system of claim 17 wherein at least one keyword and at least one advertisement are associated with at least one ad group.

21. The system of claim 17, wherein the at least a portion of the mobile advertisement campaign information is displayed in a graphical user interface to the user.

22. The system of claim 21, wherein the graphical user interface is displayed in an internet browser.

23. The system of claim 21, wherein the graphical user interface is displayed in a stand-alone application.

24. An application program interface (“API”) of an advertisement campaign management system, the API operative to facilitate communications over a network between the mobile advertisement campaign management system and an application running on a user device, wherein the API receives a request from the application running on the user device to access mobile advertisement campaign information organized into one or more ad groups associated with one or more mobile carriers and stored at the advertisement campaign management system.
